(19) United States
(12) Patent Application Publication
(10) Pub. No.: US 2016/0221288 A1
(43) Pub. Date: Aug. 4, 2016

(54) METHOD OF MAKING PRE-CURED TREAD WITH TEXTURED BOTTOM

(71) Applicants: Cesar Enrique ZARAK, Greenville, SC (US); E. Bruce COLBY, Greenville, SC (US); COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: CESAR ENRIQUE ZARAK, SIMPSONVILLE, SC (US); E BRUCE COLBY, GREENVILLE, SC (US)

(21) Appl. No.: 15/021,131

(22) PCT Filed: Sep. 8, 2014
(86) PCT No.: PCT/US2014/054466

§ 371 Date: Mar. 10, 2016

Related U.S. Application Data
(60) Provisional application No. 61/876,924, filed on Sep. 12, 2013.

(51) Int. Cl. B29D 30/54

(52) U.S. Cl. CPC B29D 30/542; B29D 2030/541; B29D 2030/544

(57) ABSTRACT

A method for preparing a retreaded tire is provided in which a bottom tread surface is configured to introduce microroughness and macroroughness thereon for adhesion with a tire carcass during a retread process. A tire tread having a tread bottom surface so configured is also provided.

### TECHNICAL FIELD

The presently disclosed invention is generally directed to methods for optimizing adhesion of a pre-cured tread during a retread process and retreaded tires derived therefrom.

### BACKGROUND

When tires become worn, they may be restored with new tread bands or tread layers during a retread process. Retreading is a restoration or re-manufacturing process that preserves much of the material in spent tires and incurs a fraction of material cost as compared to new tire manufacture. Retreading is therefore incorporated in the operation plans of many industries, including those that employ fleets of vehicles with the expectation that the tire carcasses of such vehicles will have a long service life.

For the restoration of tire treads on various vehicles, a variety of pre-cured treads have been designed for use in tire retreading processes. FIG. 1 illustrates an exemplary pre-cured tread as used on a retread tire 10. Tire 10 includes a tire carcass 12 with a crown section 14, reinforcement 16 and sidewall 18. Crown section 14 may have been buffed or otherwise worked to provide a prepared bonding surface to which a laterally extending tread 20 can be bonded. Buffing old tread off of the tire in preparation for retreading removes rubber that is typically replaced during the retreading process as part of the undertread portion of the tread that is bonded to the carcass.

A tread 20 that is applied to carcass 12 includes respective top and bottom faces 20a, 20b and a predetermined thickness T coextensive therewith. Tread 20 also extends between opposing lateral sides 20c that may be coextensive with tire carcass 12. One or more tread elements 21 are integral with tread 20 in a variety of configurations as known in the art to impart predictable and repeatable performance characteristics to any tire upon which tread 20 is employed. An undertread 23 provides a cushion and/or protective layer between the ground contacting tread and reinforcement 16 in tire carcass 12, thereby ensuring reinforcement 16 is not exposed through the wearing of the grooved tread area.

Tread 20 further incorporates a plurality of longitudinal grooves 22 that may be provided in communication with one or more lateral grooves (not shown) as known in the art. Grooves 22 have a predetermined width delineated by opposing sides 23a of adjacent tread elements 23. Each groove 22 terminates at a groove trough 22a that is offset by a predetermined distance D from tread bottom face 20b. A layer of bonding material 24 is arranged between bottom tread face 20b and tire carcass 12. In retreading operations, this offset distance often corresponds to a thickness of undertread 23 (i.e., the thickness of the undertread of pre-cured tread 20). It is understood that the undertread thickness of the pre-cured tread is differentiated from the total tire undertread thickness that is obtained after completion of a retreading process

A layer of bonding material 24 (such as a cushion gum) is arranged between bottom tread face 20b and tire carcass 12. Bonding material 24 may be selected from any amenable bonding material, including but not limited to bonding rubber and adhesive. During hot retreading processes, tires are at least partially encased in flexible covers (or “envelopes”) to create a sealed fluid chamber between the envelope and the tire. The tire and envelope are disposed in an autoclave in which air is pressurized (e.g., from between 1 to 6 bars) to force the new tread (with the bonding layer) against the carcass and thereby achieve a uniform, tight bond. The air is heated to a temperature sufficient to produce the vulcanization reaction of the bonding layer interposed between the tread and carcass.

In some retreading processes, a pre-cured tread is cured as a thick strip with a bottom of the tread being formed by a smooth press platen. Because rubber surfaces experience varying degrees of adhesion when brought into contact, bonding between the pre-cured tread and the carcass is optimized when both of the surfaces are roughened. Pre-cured tread bottoms are therefore treated with an abrasive process (e.g., wire brushing) to impart a microroughness (e.g., surface roughness components with spacing between irregularities, or spatial wavelength, less than about 100 micrometers) for purposes of adhesion.

A well-characterized surface is paramount to high production yields and long service life. Additional benefits are therefore realized by imparting a macroroughness to the tread bottom surface for enhanced mechanical adhesion.

### SUMMARY

A method for preparing a retreaded tire is provided that includes providing a tire tread having opposing top and bottom tread faces delineating a tread thickness coextensive therewith. The tire tread also includes opposing lateral sides defining a tread width with the bottom tread face configured for bonding with a tire carcass. The tire tread is applied to a tire carcass with a layer of bonding material arranged therebetween. The tire tread and tire carcass are placed under a vacuum and cured to effect adhesion of the bottom tread face to the tire carcass.

A tire tread is also provided for retreading a tire carcass. The tire tread includes opposing top and bottom tread faces delineating a tread thickness coextensive therewith, with the bottom tread face configured for bonding with a tire carcass. The tire tread also includes opposing lateral sides defining a tread width. A layer of bonding material is arranged between the tire tread and a tire carcass to which the tire tread is applied. The tire tread and tire carcass are placed under a vacuum and cured to effect adhesion of the bottom tread face to the tire carcass. In some embodiments, configuring the bottom tread may include imparting surface irregularities to a surface texture of the bottom tread face by roughening at least a portion thereof prior to applying the bottom tread face to the carcass.

Some embodiments may also include configuring the bottom tread by providing at least one circumferential groove in the bottom tread face. Each circumferential groove may have a predetermined depth, for example, of about 1 mm±0.002 mm Adjacent grooves may be provided that are spaced relative to one another, for example, on the order of about 1 mm to 4 mm±0.2 mm on center, inclusive. In particular embodiments, adjacent grooves may be spaced on the order of about 2.8 to 3.2 mm±0.2 mm on center, inclusive. The circumferential grooves may be introduced in the bottom tread face by molding the circumferential grooves into the bottom tread face prior to employment of the tread in a retreading operation. In some embodiments, the circumferential grooves may be incorporated in the bottom tread face during the brushing.

At least one circumferential groove may be provided in communication with a network of channels incorporated along at least a portion of the tread bottom face. The channels may include at least one of a plurality of lateral channels and a plurality of longitudinal channels.

Other aspects of the presently disclosed apparatus will become readily apparent from the following detailed description.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an exemplary retread tire assembly as known in the art.

FIG. 2 shows an exemplary tire tread as presently disclosed.

FIG. 3 shows an exemplary brushing apparatus used in configuring the tire tread of FIG. 2.

FIG. 4 shows an exemplary tread profile employed as a configuration for the tire tread of FIG. 2.

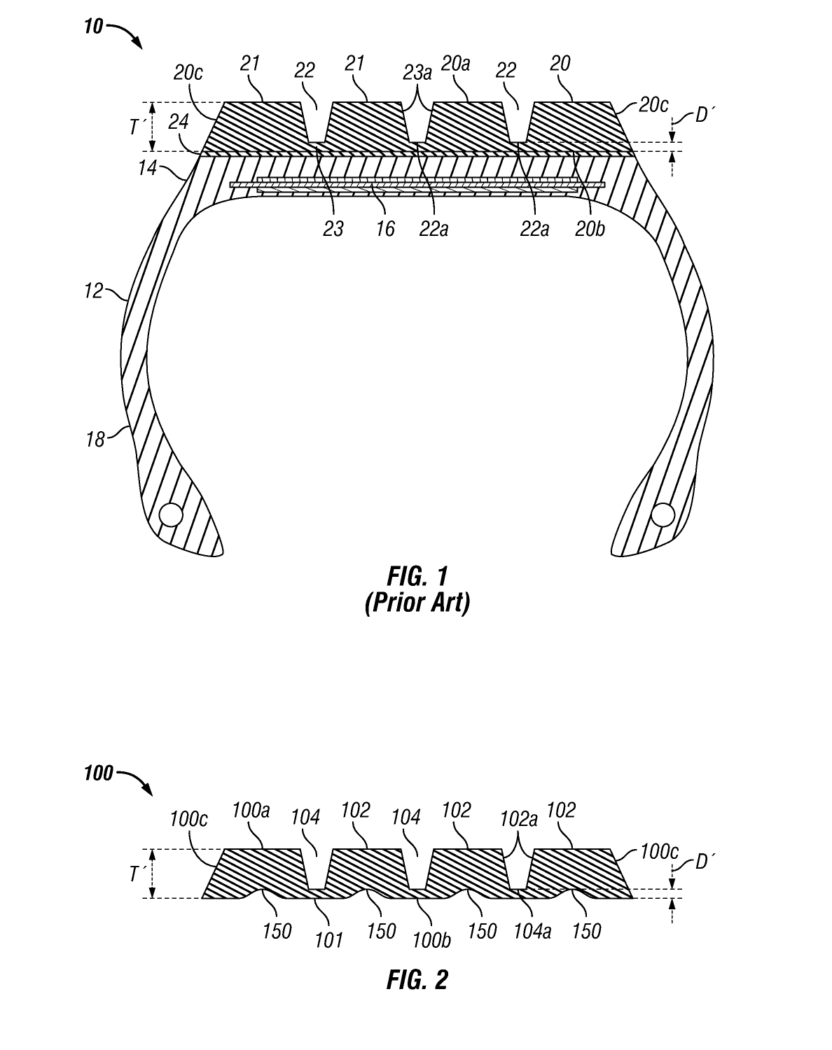

### DETAILED DESCRIPTION

Some embodiments of the presently disclosed invention include the step of providing a tire carcass configured to receive the tire tread along an annular tread-receiving area. The tire carcass generally includes a pair of beads, a pair of sidewalls, body plies and a belt package if the tire is a radial tire (otherwise, if not including a belt package, the tire is a biased ply tire). The body plies and belt package generally have plies of rubber containing strands of reinforcements. When retreading a tire, a used tire carcass is provided, which generally includes a cured tire having at least a portion of the preexisting tread removed so that a new tread may be attached to the tire carcass to form a retreaded tire. A preexisting tread may be a used or new tread, which may include an original tread formed with the tire or a retread previously installed on the tire carcass to form a retreaded tire.

The preexisting tread may be completely or partially removed to form the annular tread-receiving area. The annular tread-receiving area is arranged along a radially outer side of the tire carcass, and has a width extending laterally across a width of the tire carcass and a length extending annularly around the tire carcass. Once prepared, at least one layer of bonding material (also referred to as a “bonding layer”) is arranged along the annular tread-receiving area between the tread and the tire carcass to facilitate bonding of the tread to the tire carcass. It is understood that the bonding layer may include any bonding material known for bonding the pre-cured tire tread to a tire carcass. For example, the bonding material may include any elastomeric or polymeric material, such as natural or synthetic rubber, which is curable and promotes bonding by way of cross-linking. In some embodiments, assembling is effected with a bonding layer that includes uncured bonding material.

Some embodiments of the presently disclosed invention include a step of curing the tread to the tire carcass. It is appreciated that any known method for curing the tread to the tire carcass may be employed. In some embodiments, for example, a flexible curing membrane (or “envelope”) is arranged along the top side of the tire tread. In arranging a flexible curing membrane about at least a portion of the tread of the assembled retreaded tire, a sealed fluid chamber is formed between the flexible curing membrane and the tire. When assembled, the flexible curing membrane and the tire form a tire-membrane assembly. It is understood that the flexible curing membrane maintains proper position of the new tread relative to the tire carcass. The membrane also facilitates a pressure differential between the membrane compartment (and the sealed tire assembly) and a curing chamber of the curing vessel, within which the tire-membrane assembly is arranged to cure the tread to the tire carcass by application of heat and/or pressure according to any desired curing law. It is further understood that the flexible curing membrane may include any flexible membrane for curing a tire, which membrane may include one or more curing membranes arranged about the tire. For example, a membrane may extend substantially around the entire tire, the membrane comprising one or more sections.

The retread curing process is performed generally within a curing vessel such as an autoclave. The curing vessel generally includes a curing chamber providing a controlled environment in which the tire-membrane assembly cured. Generally during the curing process, the chamber is pressurized to a desired pressure and heated to a desired temperature based upon a recipe or formula. In performing the step of curing, particular embodiments of such methods include placing the sealed fluid chamber of the tire-membrane assembly under substantial vacuum. This generally occurs at the beginning of the curing process, before pressure and heat is applied to the tire-membrane assembly in a curing chamber of a curing vessel. As used herein, “vacuum” or “under vacuum” means providing a fluid pressure equal to zero psia (pounds per square inch absolute), and “substantial vacuum” or “substantially under vacuum” means 5 to 0 (zero) psia. Additional steps of such methods may further include connecting a fluid passage to the curing membrane of the tire-membrane assembly to place the sealed fluid chamber in fluid communication with a pressure source (configured to provide positive pressure and/or vacuum pressure as needed). A pressure source may comprise a compressor or any other device known to one of ordinary skill in the art.

Now referring to the figures, wherein like numbers represent like elements, FIG. 2 shows an exemplary pre-cured tread 100 that is provided for application to a tire carcass (not shown). The carcass is of similar original tread design to a pre-cured tread sculpture of tread 100. During the retreading process, at least a portion of the preexisting tread is removed to a desired depth by performing a buffing or abrading operation. Buffing may be accomplished by one or more buffing or abrasion tools as known in the art. Such buffing or abrasion tools may include, but are not limited to, cylindrical cutters (or “peelers”) and abrading devices such as rasps, grinding wheels and wire brushes. The material that is removed from the tire to be retreaded creates waste that is discarded and then replaced with new material that is bonded to the tire carcass during the retreading process.

Tread 100, fabricated with an undertread 101 of predetermined thickness, includes respective top and bottom tread faces 100a, 100b and a predetermined thickness T′ coextensive therewith. Tread 100 also extends between opposing lateral sides 100c that may be coextensive with the tire carcass. One or more tread elements 102 are integral with tread 100 in a variety of configurations as known in the art. It is therefore understood that the configuration of tread 100 is not limited to that shown herein and that a variety of tread configurations are amenable for use with the carcass.

Tread 100, and particularly top tread face 100a thereof, further incorporates a plurality of longitudinal grooves 104 that may be provided in communication with one or more lateral grooves (not shown) as known in the art. Grooves 104 have a predetermined width delineated by opposing sides 102a of adjacent tread elements 102. Each groove 104 terminates at a groove trough 104a that is offset by a distance D′ from bottom tread face 100b, which distance corresponds to the thickness of undertread 101.

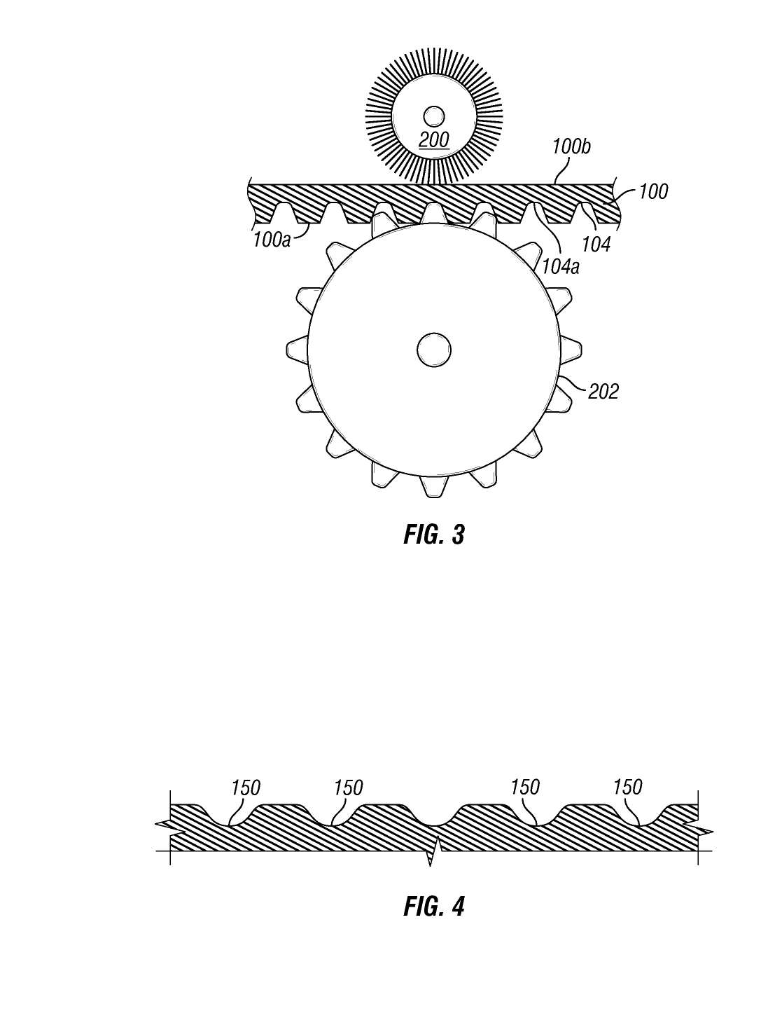

Referring further to FIG. 2 and additionally to FIG. 3, bottom tread face 100b is prepared for bonding before pre-cured tread 100 is assembled with the carcass. For example, the bottom tread face is textured or roughened so that contaminants and foreign matter (including mold release agents) are removed, thereby facilitating sufficient adhesion and bonding of the tread to the tire carcass. To accomplish this, a texturing implement as known in the art is employed to abrade bottom tread face 100b. Such buffing element may be a rotary buffing member and any equivalent and complementary device having adjustable rotational speed and subject to variances in the velocity of the traverse across the bottom tread surface.

Referring further to FIG. 3, one known texturing process uses a brush or abrasive roller 200 to roughen bottom tread face 100b while tread grooves 104 are supported by a support roller 202 (reference is made to co-owned U.S. Pat. No. 8,303,371, the entire disclosure of which is incorporated by reference herein). Abrasive roller 200 may be a brushing wheel or any other equivalent device for imparting a texture to tread bottom face 100b. It is understood that abrasive roller 200 may be employed with a moveable track and multiple roller. It is also understood that brushing process may vary and that the presently disclosed invention is amenable for practice with numerous existing brushing processes without requiring deviation therefrom.

In preparing for bonding, the brushing wheel (or like device) introduces surface irregularities in the surface texture, which irregularities are represented by roughness, waviness and form. Such parameters are the result of the buffing process employed to create microroughness, and they may be varied to introduce beneficial macroroughness in the surface of bottom tread face 100b.

Additional adhesion benefits are derived from a macroroughness created upon buffing tread bottom face 100b having one or more circumferential grooves 150 molded therein. As further shown in the exemplary profile of FIG. 4, each groove 150 has a depth of about 1 mm±0.002 mm and adjacent grooves are spaced on the order of about 1 mm to 4 mm±0.2 mm on center, inclusive. In some embodiments, beneficial macroroughness has been observed with grooves of the same depth spaced from about 2.8 to 3.2 mm±0.2 mm on center, inclusive.

In such configuration, bottom tread face 100b is effectively brushed using existing brushing equipment and processes to produce a circumferentially aligned macroroughness with all brushed surfaces exhibiting a microroughness as well. For pre-cured treads so treated, an increased area of contact has been observed between tread bottom face 100b and the carcass, thereby accentuating adhesion therebetween. In some instances, the observed area of contact is about 50% greater than an area of contact observed using brushing without the presently disclosed bottom tread grooves.

It is further understood that grooves 150 may be provide in communication with one another via intersecting lateral grooves channeled to a wick inside the envelope (not shown). During a retread curing operation, that is, in preparation for and during a retread curing process, each tire-envelope assembly may at certain instances be placed under vacuum. While under vacuum, the curing chamber is also positively pressurized, such that a pressure force is applied to the envelope. Accordingly, the envelope is forced into grooves of the tread during curing operations. In embodiments that employ grooves 150 in communication with the wick, the envelope vacuum effectively removes all air from between the tread and the carcass bonding layer without effecting changes to a standard retread process.

In some embodiments, tread bottom face 100b has circumferential grooves 150 in communication with a network of channels (not shown) incorporated along at least a portion of the tread bottom face. In some embodiments, the channel network includes a plurality of lateral and longitudinal channels sufficient to transport air across bottom tread face 100b. The channels may be located under thicker portions of tread 100 (i.e., those portions corresponding to tread elements 102), representing the wear indicators. The grooves and channels are all in communication with a vacuum outlet (not shown) that permits curing of the retreaded tire without an envelope.

In some embodiments, the channel network includes a series of continuous longitudinal channels provided in communication with a plurality of lateral channels. It is understood, however, that the channel network may include a network architecture having only lateral channels, or one having only longitudinal channels. It is also understood that other network architectures may be employed by the channel network that are amenable to practice of the presently disclosed invention. For example, a network of channels may be provided comprising a plurality of acute-angled cells. As disclosed herein, grooves 150 were molded into the pre-cured tread and were found to be effective in that bottoms of the valleys could be reached with standard brushing techniques and imparted over 100% of the surface with microroughness. It is understood that, while circumferential grooves 150 may be molded into bottom tread face 100b prior to employment of the tread in a retreading operation, in some embodiments, the grooves may be incorporated during the brushing process. For example, for embodiments incorporating a channel network, if application of circumferential grooves 150 is incorporated during the brushing process, it is understood that the channel network may be provided in the carcass rather than being molded into tread bottom face 100b. Such an application avoids the temporal and fiscal costs associated with double molding.

The presently disclosed invention enhances the attributes of tread adhesion by introducing macroroughness on the tread bottom surface. The ability to adjust and modify roughness, waviness and form also contributes to the ability of the envelope vacuum to remove air between the tread and the carcass (even, in some embodiments, optimizing the curing process to as to obviate the need for a cure envelope). The ability to produce a specific surface roughness depends on many factors. For example, the final surface depends on the rotational speed of the buffing member, the velocity of the traverse across the bottom tread surface and the mechanical properties of the tread. A small change in any of these factors can have a significant effect on the surface produced, as realized by the embodiments disclosed herein and the surprising results obtained thereby.

It is understood that the presently disclosed methods may be employed on tires that have never been retread. It is further understood that the presently disclosed methods are contemplated for use on tires that have previously been subject to one or more retread processes, either as disclosed herein or according to one or more other amenable retreading methods. The presently disclosed invention may be utilized in association with retreaded heavy duty truck or trailer tires and any other tire type, including but not limited to light truck, off-road, ATV, bus, aircraft, agricultural, mining, bicycle, motorcycle and passenger vehicle tires.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the disclosed apparatus have been illustrated and described, it will be understood that various changes, additions and modifications can be made without departing from the spirit and scope of the present disclosure. Accordingly, no limitation should be imposed on the scope of the presently disclosed invention, except as set forth in the accompanying claims.

What is claimed is:

1. A method of preparing a retreaded tire, the method comprising the steps of:
providing a tire tread having opposing top and bottom tread faces delineating a tread thickness coextensive therewith, and opposing lateral sides defining a tread width;
configuring the bottom tread face for bonding with a tire carcass;
applying the tire tread to a tire carcass with a layer of bonding material arranged therebetween;
placing the tread and tire carcass under vacuum; and
curing the tire tread and the tire carcass to effect adhesion of the bottom tread face to the tire carcass;
wherein the tread includes a plurality of circumferential grooves in the bottom tread face and surface irregularities imparted to the bottom tread face by roughening.

2. (canceled)

3. The method of claim 1, wherein each circumferential groove has a depth of about 1 mm and adjacent grooves are spaced on the order of about 1 mm to 4 mm on center, inclusive.

4. The method of claim 3, wherein adjacent grooves are spaced on the order of about 2.8 to 3.2 mm on center, inclusive.

5. The method of claim 4, further comprising placing the tread and tire carcass in a curing envelope during curing and while the tread and tire carcass are under vacuum.

6. The method of claim 5, wherein one or more lateral grooves are provided in communication with at least one of the curing envelope and the plurality of circumferential grooves.

7. The method of claim 5, wherein the plurality of circumferential grooves is provided in communication with a network of channels incorporated along at least a portion of the tread bottom face, and the channels include at least one of a plurality of lateral channels and a plurality of longitudinal channels.

8. The method of claim 4, wherein the plurality of circumferential grooves in the bottom tread face:
are molded prior to roughening the bottom tread face.

9. The method of claim 8, wherein roughening is effected by a brushing wheel.

10-12. (canceled)

13. A tire tread for retreading a tire carcass, the tire tread comprising:
opposing top and bottom tread faces delineating a tread thickness coextensive therewith, with the bottom tread face configured for bonding with a tire carcass; and
opposing lateral sides defining a tread width;
wherein the bottom tread face is configured with a plurality of longitudinal grooves and surface irregularities that are imparted to a surface texture of the bottom tread face by roughening.

14. (canceled)

15. The tire tread of claim 13, wherein each longitudinal groove has a depth of about 1 mm and adjacent longitudinal grooves are spaced on the order of about 1 mm to 4 mm on center, inclusive.

16. The tire tread of claim 15, wherein adjacent grooves are spaced on the order of about to 3.2 mm on center, inclusive.

17. The tire tread of claim 16, wherein the longitudinal grooves are provided in communication with a network of channels incorporated along at least a portion of the tread bottom face, and the channels include at least one of a plurality of lateral channels and a plurality of longitudinal channels.

18-24. (canceled)
